(19) United States
(12) Patent Application Publication
(10) Pub. No.: US 2005/0120135 A1
(43) Pub. Date: Jun. 2, 2005

(54) Method and apparatus for configuring a router

(76) Inventors: Gergely Molnar, Budapest (HU); Attila Rajmund Nohl, Budapest (HU)

Correspondence Address: ERICSSON INC., 6300 LEGACY DRIVE, M/S EVR C11, PLANO, TX, 75024, US

(21) Appl. No.: 10/497,100

(22) PCT Filed: Dec. 3, 2001
(86) PCT No.: PCT/IB01/02777

(51) Int. Cl. G06F 15/173; G06F 15/16

(52) U.S. Cl. 709/242; 709/201; 709/238

(57) ABSTRACT

In this method for configuring a router in a telecommunications network, the router having a configuration file, after turning the router an and selecting a default interface, the router automatically performs steps comprising, a) a connection step (50, 52, 54, 56), for establishing a logic connection with a predetermined neighbour router; b) an information gathering step (58), for obtaining anformation about the configuration file; and c) a data downloading step (59), for downloading the configuration file. Application to routers in IP based mobile access networks.

The present invention relates to a method and apparatus for configuring a router.

The invention finds application in the field of telecommunication networks. It is described here, by way of non-limiting example, in its application to a network of the Internet type.

Internet Protocol (IP) is a communication protocol that interconnects various hosts. In general, IP hosts are computers implementing an IP protocol stack and applications.

A set of directly connected hosts, e.g. a set of hosts sharing one and the same cable, are able to communicate directly with each other. Such a construction is called an IP network or sub-network, or simply an IP subnet.

In the case where these hosts are not connected directly, e.g. there are two separated physical links, additional equipment is needed in order to provide IP connectivity between the hosts on these physically separated IP subnets. Such equipment is referred to as a router.

A router connects a plurality of IP subnets and enables hosts of different subnets to “talk” to each other through the router.

The router is a computer having hardware and software adapted to forward received IP packets sent by the hosts.

As is well known by a person skilled in the art, an IP host and an IP router have quite different configurability properties. Configuring has the meaning of assigning specific values to a set of attributes that are to control operation of equipment.

For an IP host, few attributes need to be set. By contrast, for an IP router, the number of these attributes is much greater. Depending on the size of the router—access, aggregation, enterprise, backbone, etc.—the number of those attributes which have to be configured may vary from about 10 to about 500 or more.

The configuration process consists in finding out what values are needed for what attributes and in setting them somehow.

In the prior art, this task is generally carried out manually, by the network administrator.

A basic general method to configure a router, well known to a person skilled in the art, is manual configuration using the Command Line Interface (CLI) of the router. Such a method is referred to hereinafter as “the CLI method”.

However, configuring a router using its CLI is generally quite time-consuming. The greater the number of routers contained in the network, the more this drawback becomes significant.

Besides, the network administrator must generally have a connection with the router. In many cases, initial configuration can only be performed-on a console that is on a special port of the router, where a terminal can be connected directly.

If the router is on a site far away from the management centre, the CLI method has also the disadvantage of not being cost effective, for example if an expert must be sent out to the site for configuring the router.

Another known method, which is very similar to the CLI method but which generally does not require the expert to go out into the field when creating values for the attributes of the router, consists in constructing a configuration file that contains those same CLI commands which would be directly typed into the CLI by the network administrator. Such a method is referred to hereinafter as “the configuration file method”.

As is well known by a person skilled in the art, a configuration file is an ASCII file that contains the desired configuration parameters of the router. It consists of CLI commands and can be made, either with a simple, conventional ASCII editor, or with a comprehensive tool, such as Cisco's ConfigMaker or Ericsson's NRM for AXI540 and AXI520 routers.

The configuration file method can be carried out in the management centre. The configuration file can be downloaded into the router using TFTP (Trivial File Transfer Protocol) or FTP (File Transfer Protocol).

Nevertheless, so as to initiate the downloading, the administrator has to establish a connection to the router and has to send appropriate CLI commands to trigger downloading and execution of a configuration file by the router. These steps can also be very time-consuming, especially for initial configuration of a network comprising many routers.

Still another known method, known as Cisco System's AutoInstall, consists in first resolving the interface IP address, e.g. using SLARP (Serial Line Address Resolution Protocol) if the interface has a serial link. If the interface is of the Ethernet type, then RARP (Reverse Address Resolution Protocol) is used. But this requires a configured RARP server in the network.

The router being configured tries to map its IP address to name-sending TFTP broadcast, in order to fetch a so-called “network-confg” file. Then the router attempts to download a so-called “newrouter.cfg” file, by means of TFTP. This latter file is the configuration file for the router.

For more details about Cisco System's AutoInstall, reference can usefully be made to Cisco's Documentation CD or its online version on the Internet at the address “http://www.cisco.com/univercd/home/home.htm”.

This latter known configuration method has a number of limitations.

Firstly, it implements a proprietary protocol, only known and usable by Cisco routers. Consequently, the method can only work between two Cisco routers. It also uses a TFTP broadcast that requires Cisco specific router helper address support.

Secondly, it is mostly dedicated to small-size networks, typically campus or enterprise networks and it is not well suited for larger networks. In this respect, account has to be taken of the fact that it is envisaged to settle, in the near future, IP networks such as radio access networks of the IP-BSS (Internet Protocol-Base Station System) type, which are IP based GSM (Global System for Mobile communications) radio access networks containing a huge number of routers.

For example, assuming that a North-American access network may contain more than 10,000 base stations and given the fact that an IP-BSS base station contains a router, it can lead to more than 10,000 routers in such a network.

Where enormous amounts of attributes are to be configured, with a significant configuration time resulting therefrom, known methods of router configuration cannot be applied in practice.

The present invention aims at simplifying the configuration process in order to overcome the above-mentioned drawbacks.

To this end, the present invention provides a method for configuring a router in a telecommunications network, wherein the information data relating to the configuration of the router are stored in a configuration file in the telecommunications network, the method being remarkable in that, after turning the router on and selecting a default interface, the router automatically performs steps comprising:
a connection step, for establishing a logic connection with a predetermined neighbour router;
an information gathering step, for obtaining information about the configuration file; and
a data downloading step, for downloading the configuration file.

Thus, the configuration of the router takes place automatically upon switching on of the router and is carried out centrally in one and the same location.

In a preferred embodiment, during the information gathering step, information is obtained about the location of the configuration file and the way of accessing it.

With the same object as above, the invention also provides a computer program product, loadable into a computer, remarkable in that it comprises software code portions for implementing the steps of a method as succinctly described above when this product is run on a computer.

The configuration method according to the invention can easily be implemented in the router system software. For example, it can be the default initial sequence performed by the router when the latter is turned on.

With the same object as above, the invention also provides an apparatus for configuring a router in a telecommunications network, wherein the information data relating to the configuration of the router are stored in a configuration file in the telecommunications network, the apparatus being remarkable in that it comprises:
a connection unit, for establishing a logic connection with a predetermined neighbour router;
an information gathering unit, for obtaining information about the configuration file; and
a data downloading unit, for downloading the configuration file.

In a preferred embodiment, the connection unit comprises a connection manager, the information gathering unit comprises a DHCP client and the data downloading unit comprises an FTP/TFTP client.

The invention is advantageously applied in the case where the network is an IP based mobile access network.

In fact, the invention is particularly suited for geographically large networks. The installation of a huge amount of routers can be done very efficiently, since configuration data can be handled centrally. Equipment only needs to be brought out to the site and turned on.

By virtue of the invention, network operators' costs can be reduced, because it does not require that experts be sent to the site, which is sometimes far from the network management centre.

With the same object as above, the invention further provides a router, remarkable in that it includes processing means adapted to implement a method as succinctly described above.

Other features and advantages of the present invention will appear upon reading the following detailed description of a preferred embodiment, given by way of non-limiting example.

The description refers to the accompanying drawings, in which:

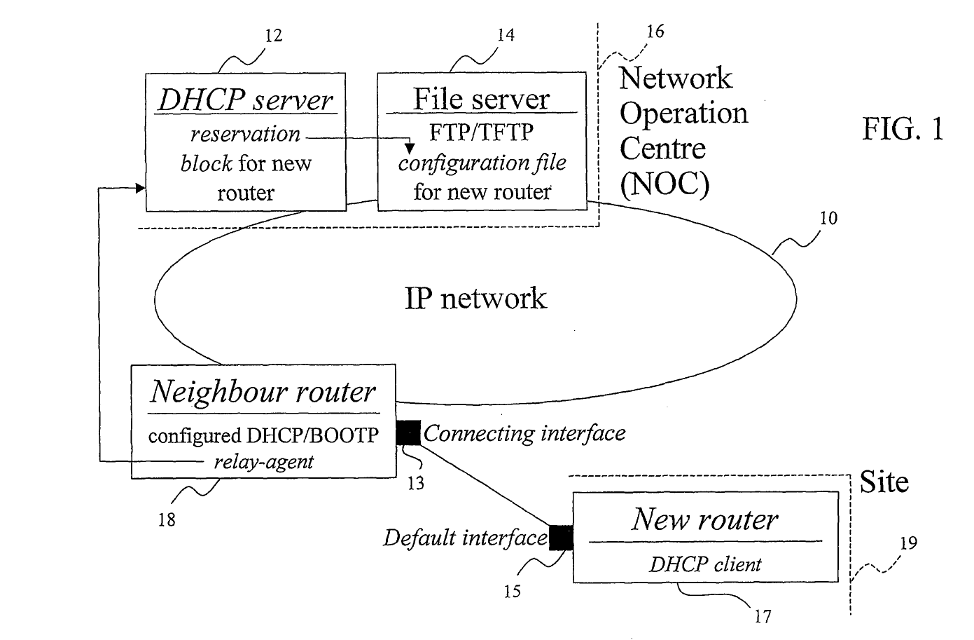

FIG. 1 is an overview of participants and relations involved in the method and apparatus according to the present invention, in a preferred embodiment;

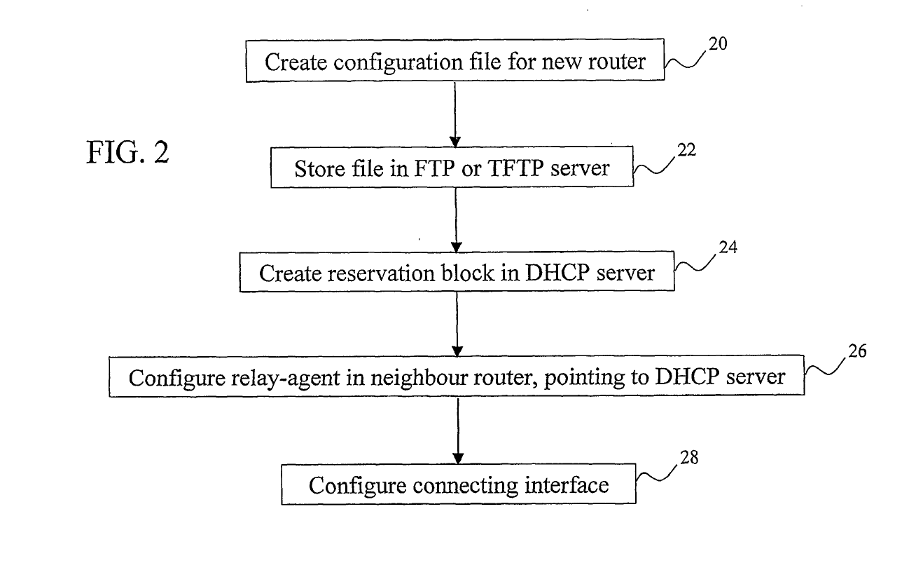

FIG. 2 is a flowchart showing the preparation process being carried out at the NOC (Network Operation Centre) in view of the implementation of the present invention, in a preferred embodiment;

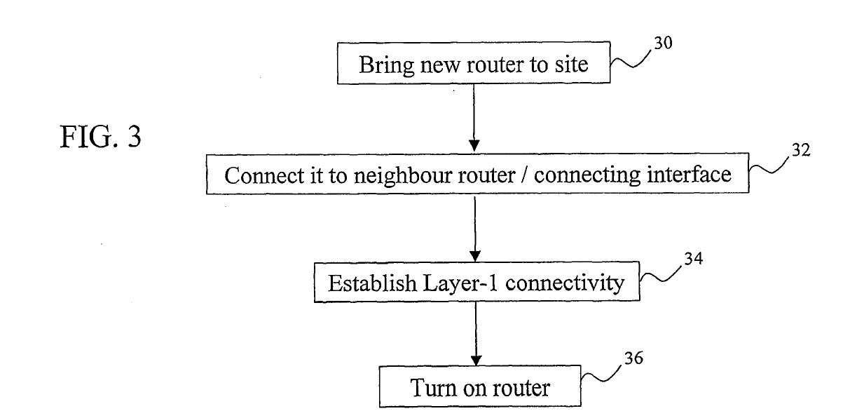

FIG. 3 is a flowchart showing the preparation process being carried out on the new router's site in view of the implementation of the present invention, in a preferred embodiment;

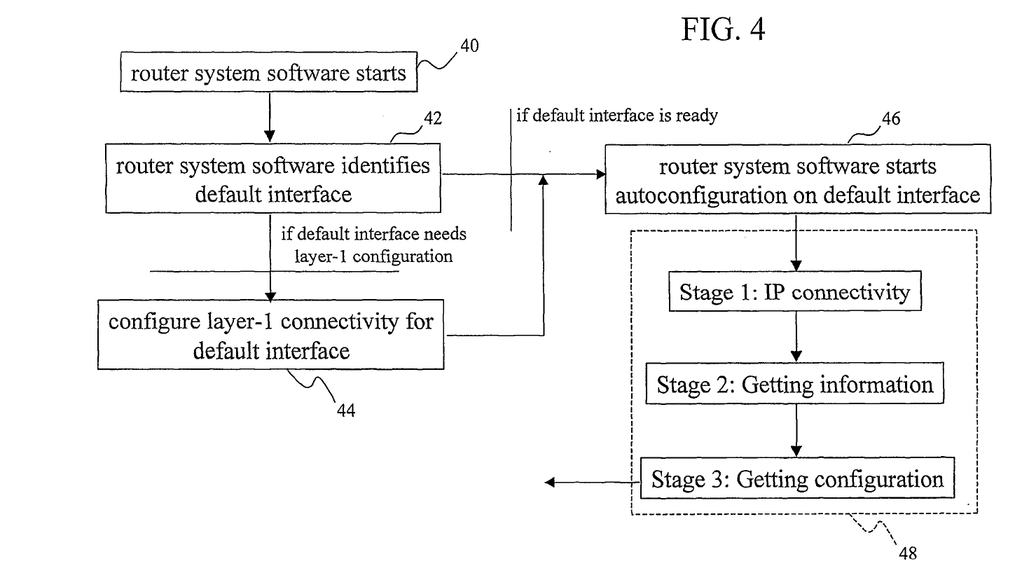

FIG. 4 is a flowchart showing the outline of the present invention, in a preferred embodiment;

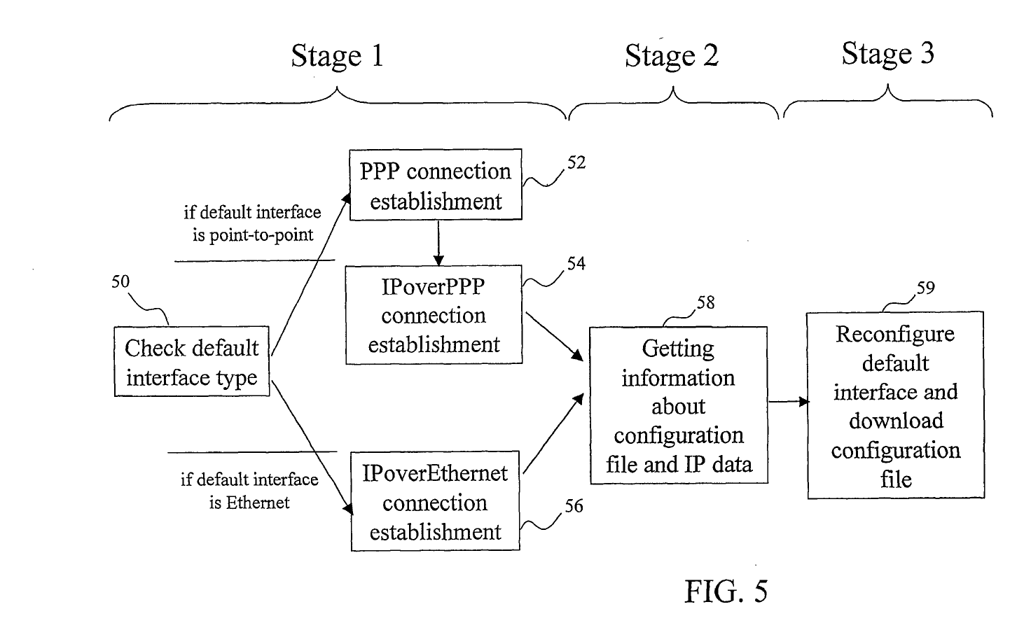

FIG. 5 is a flowchart showing successive steps of the autoconfiguration process carried out by the router in the method according to the present invention, in a preferred embodiment; and

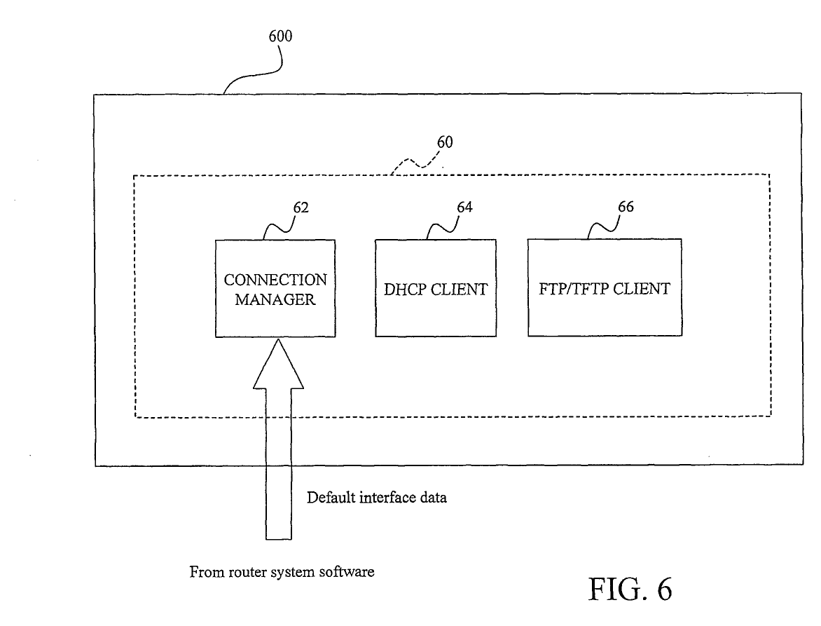

FIG. 6 is a diagram illustrating an apparatus for configuring a router according to the invention, in a preferred embodiment.

In the following description, it is assumed that the invention is implemented in the router system software. For example, the router system software can be easily loaded into the router at the time of manufacture. However, such implementation is given by way of non-limiting example.

It is also assumed that the data necessary for configuring the router are prepared and stored in appropriate places. The method and apparatus described then make it possible to build a connection to the network, to find the appropriate configuration data and to transfer them into the router.

For clarity, definitions of a number of terms used in the present description are given below:
DHCP (Dynamic Host Configuration Protocol): this client/server configuration protocol enables computers to obtain configuration information from the server, e.g. an IP address, a subnet mask, a router default address, a DNS (Domain Name System) server default address, etc. DHCP is defined officially in document RFC (Request For Comments) 1541, to which reference can be made for more details about this protocol.

As is known by a person skilled in the art, RFC's are technical reports stored on-line describing protocols, network interfaces and other subject-matter relating to the computer in the Internet context. They can be found at the following Web address: http://www.ietf.org/rfc.html
DHCP server: this type of Internet network server implements the server functionality of the DHCP standard protocol. According to the invention, the DHCP server is used for storing information about the configuration file (location, access mode, etc.) and for serving IP addresses in order to build IP connectivity.
DHCP client: this type of Internet network client implements the client functionality of the DHCP standard protocol. According to the invention, the DHCP client is used for finding the administering DHCP server and for obtaining the necessary information (IP address for the default interface, information about the location of the configuration file and its access mode, etc.).
DHCP relay-agent: this type of Internet network entity implements the relay-agent functionality of the DHCP standard protocol. The DHCP relay-agent is needed when the DHCP client and the DHCP server are on different subnets, for relaying DHCP messages from the client to the server and vice-versa.
reservation block: an item stored in a DHCP server. According to the invention, the reservation block may serve inter alia the following data:
(i) an IP address for the default interface; since the entire interface configuration is in the configuration file, this IP address may indifferently be the same as the IP address in the configuration file for the default interface, or different therefrom; a subnet mask should be added to the IP address, for example by using the “subnet-mask” DHCP option;
(ii) a DNS server address; this may be obtained through the “domain-name-server” DHCP option;
(iii) information about the location of the configuration file and the method for accessing same;
in case of FTP access, such information may be obtained by means of the standard “tftp-server-name” DHCP option, filled with a string using the format <username>@<password>:<server-address or name>, where “username” and “password” are the appropriate user's account name and the user's password, which can be used for an FTP session in order to download the configuration file, and “server-address or name” is the address or name of the server where the configuration file is stored;
in case of TFTP access, information about the location of the configuration file and the method for accessing it may be obtained by means of the standard “tftp-server-name” DHCP option, filled with a string using the format <server-address or name>;
(iv) information about the name of the configuration file: such information is provided by using the standard “bootfile-name” DHCP field.
new router: the router that is being deployed and configured thanks to the present invention.
neighbour router: the router to which the new router will be connected.
connecting interface: the interface of the neighbour router, where the new router will be connected physically.
default interface: this interface of the new router is the one which is being used when carrying out the invention. It can be chosen by any kind of method, provided the router system program is able to supply information about this default interface when the configuration process according to the invention is started.
link-local net address: a special type of IP address, for local use only, and not forwarded between subnets. There are specific network prefixes for both IPv4 and IPv6, respectively (namely, 169.254/16 and FE80::<64 bit EUI-64 interface ID>, respectively).

The main participants and relations involved upon implementing the present invention are shown diagrammatically in FIG. 1.

As mentioned in the introduction, the invention is described here in its application to a network based on Internet Protocol. An IP network 10 is depicted on the drawing.

A DHCP server 12 and a file server 14 using FTP or TFTP are located in a Network Operation Centre (NOC) 16. As known by a person skilled in the art, a NOC manages, supports and administers the computing and networking resources.

The DHCP server 12 is adapted to store a reservation block for a new router 17 located on a site 19. The new router 17 is a DHCP client.

The file server 14 is adapted to store a configuration file for the new router 17.

A neighbour router 18 is also shown.

In the preferred embodiment that is described here, the neighbour router 18 includes a relay-agent, which is assumed to be configured by means of the protocol DHCP or BOOTP (this latter bootstrap protocol, known by a person skilled in the art, is described in RFC 951).

In case there are several DHCP servers, a number of reservation blocks intended for a number of new routers, respectively, may be distributed between these DHCP servers. In such a case, care should be taken when configuring the relay-agents in the respective neighbour routers, so that each of the relay-agents points to the right DHCP server.

As shown in FIG. 1, the neighbour router 18 has a connecting interface 13 and the new router 17 has a default interface 15. Between the connecting interface 13 and the default interface 15, there is a connection of the Ethernet type or of the PPP (Point to Point Protocol)/serial type.

On the drawing, the arrow between the DHCP server 12 and the file server 14 indicates that the reservation block stored in the DHCP server 12 contains information about the location of the configuration file (e.g. host name/address and file path). There is a pointer to the file in the reservation block.

The arrow between the neighbour router 18 and the DHCP server 12 means that the relay-agent is configured to point to the DHCP server 12. the relay-agent communicates with the DHCP server 12 in particular for obtaining the reservation block for the new router 17.

Thus, the new router 17 will locate the configuration file through the obtained reservation block and will be able to initiate downloading of the configuration file from the pointed file server, by requesting the pointed file.

FIGS. 2 and 3 show steps of the preparation processes being carried out, on the one hand, at the Network Operation Centre (NOC) and, on the other hand, on the new router's site.

As shown in FIG. 2, before turning the new router on, a number of preliminary steps are taken at the management centre, for example by the network administrator, either manually, or with the help of an appropriate program leading the administrator through at least some of the necessary steps.

As a first step 20, a configuration file is created for the new router 17.

Next, the configuration file is stored in the file server 14, which is of the FTP or TFTP type and has proper access control (step 22).

An appropriate reservation block is also created in the DHCP server 12, using the access information and data of the file server 14 and relating to the path of the configuration file (step 24).

Moreover, in the neighbour router 18, if this is not done yet, a DHCP relay-agent is configured and adapted so as to communicate with the DHCP server 12 that contains the reservation block for the new router 17 (step 26).

Another optional preliminary step consists, where necessary, in configuring the connecting interface 13 (step 28).

Steps 20, 22, 24, 26 and 28 above are shown as a succession of steps in FIG. 2. However, these steps may equally be performed in a different order (step 22 being of course not performed before step 20).

FIG. 3 shows steps of the preparation process being carried out on the new router's site 19.

The new router 17 is first brought to the site 19 (step 30).

It is then physically connected to the neighbour router 18 through to the interface of the neighbour router, i.e. the connecting interface 13 (step 32).

If necessary, an additional step 34 consisting in establishing Layer-1 connectivity, i.e. physical connectivity, within the meaning of the 7-layer OSI model, is carried out.

The new router 17 is then turned on (step 36). It can then be seen as an IP host with one interface, namely, the default interface 15.

After the new router 17 is turned on, the following sequence of steps take place, as shown schematically in FIG. 4.

The router system software is started (step 40). Some internal, conventional checks may be made by the router upon booting, such as checking the memory, checking hardware components, etc.

At this stage, since the router system software has to find the default interface 15, Layer-1 parameters on the default interface have to be configured, if not done yet. Such physical configuration of the default interface 15 may be done either manually by entering a very few parameters on the site 19, or using an automatic method. Depending on the type of the default interface, no particular handling may be required (e.g. if the default interface is of the Ethernet type), or some setup steps may be needed; for instance, if the default interface is of the fractional E1 type, the underlying SDH (Synchronous Digital Hierarchy) connection has to be set up appropriately as known by the SDH administrator.

Then, the router system software identifies the default interface 15 (step 42). If the default interface needs Layer-1 configuration, a step 44 is performed, consisting, as mentioned above, in configuring Layer-1 connectivity for the default interface. If the default interface is ready, the router system software determines a default interface identifier (step 46) and starts an autoconfiguration process (step 48).

As detailed below in reference to FIG. 5, the autoconfiguration step 48 comprises three main stages.

The first stage (referred to as “Stage 1” in FIGS. 4 and 5) is for establishing IP connectivity between the new router 17 and the neighbour router 18. The second stage (“Stage 2” on the drawings) is for getting information about the configuration file of the new router 17. The third stage (“Stage 3”) is for getting the configuration file and downloading it into the new router 17.

If all of the three stages are performed without failure, the new router 17 can then interpret, e.g. parse, its configuration file and start to use its routing functionality, as instructed by the obtained configuration.

In the event of a failure, the router system software requests manual configuration or is started again for a new attempt.

As shown in FIG. 5, once the default interface 15 is selected, the new router 17, as an IP host, tries to establish IP connection to the network. To this end, the new router 17 performs a step 50 consisting in checking the default interface type. The default interface 15 may be of the PPP type, e.g. E1/T1, fractional E1, synchronous serial, etc. As a variant, it may be of the LAN (Local Area Network) type, e.g. Ethernet.

If the default interface 15 is a PPP interface, it is necessary to establish PPP connection (step 52). The new router 17 tries to connect to the connecting interface 13 by using the PPP link-control protocol.

Assuming that the connecting interface 13 is ready to accept the new router's PPP connection request (see step 28 above), the PPP connection will be established.

For IP connection, the new router 17 may use the IP control protocol, in order to establish IPoverPPP connection (step 54). To do this, the new router 17 may use a link-local net address as its PPP client address.

If the default interface 15 is a LAN interface, it can be used for IP as it is. The source IP address may optionally be set to a link-local net address, this being however unnecessary. The unknown-source address (0.0.0.0) may be used in DHCP interactions. IPoverEthernet connection is then established (step 56). On the other hand, if a link-local net address is used, its uniqueness should be checked.

At this stage, the new router 17 can act as an IP host and can use DHCP based configuration at the following step 58, consisting in getting information about the configuration file and IP data. For example, it can send DHCPDISCOVERY messages on the default interface.

In the case where the administering DHCP server 12, which has the reservation block for the new router, is on the same link as the new router (e.g. Ethernet), then during step 58, the DHCP server 12 can answer directly to the router.

In the case where the DHCP server 12 is in another subnet, then during step 58, the DHCP relay-agent in the neighbour router 18 will relay messages between the DHCP client (i.e. the new router 17) and the DHCP server 12.

Upon reception of the new router's request, the DHCP server 12 answers by returning in a conventional manner the reservation block to the router 17.

After having received the reservation block, the new router 17 has a site global IP address for the default interface and knows where the configuration data is and how such data can be accessed and obtained.

The new router 17 then initiates an FTP or TFTP session, depending on the instructions resulting from the reservation block, in order to download the configuration file (step 59). Once the configuration file has been successfully downloaded into the new router, the entire router configuration is available.

The new router then interprets the downloaded configuration file and starts its router functionality.

Depending on the content of the configuration file, the default interface may be reconfigured, services may be configured, protocols may be started and configured, etc.

Thus, according to the invention, the entire configuration of the new router can be made in one and the same place in the network, independently of the location of the new router, and the new router will obtain configuration data automatically when it is turned on.

In order to be fully functional, the router also needs an appropriate routing/forwarding table. To this end, as a first option, static routers may be used, which are explicitly set by the network administrator. As a variant, which is preferred, dynamic routing may be used, in which case a dynamic routing protocol is set up in the new router, such as OSPF (Open Shortest Path First), RIP (Routing Information Protocol) or IS-IS (Intermediate System to Intermediate System), for configuring the router table. A third option consists in combining the first two options. Dynamic routing is advantageously used in the context of the present invention, since it may significantly decrease the configuration effort of the network administrator.

The new router is then fully functional. It may for instance act as a neighbour router for another new router.

As shown in FIG. 6, the main component of an apparatus 600 according to the invention is an autoconfiguration controller 60, which controls execution of the steps of the automatic router configuration method described above.

The autoconfiguration controller 60 uses mainly three components:
a connection manager 62, which is adapted to perform the connection step, i.e. stage 1 described above with reference to FIG. 5;
a DHCP client 64, which is adapted to perform the information gathering step, i.e. stage 2; and
an FTP/TFTP client, which is adapted to perform the configuration file downloading step, i.e. stage 3.

When the system is started, the controller 60 receives from the router system software a plurality of data identifying the default interface and defining its type.

The connection manager 62 manages IP level connectivity between the default interface 15 of the new router 17 and the connecting interface 13 of the neighbour router 18, depending on the type of the interface.

When the IP connection is established, the controller 60 starts the next stage: using the DHCP client, it starts the DHCP session to obtain the reservation block from the DHCP server.

The controller 60 next uses the connection manager 62 in order to reconfigure the IP connection to the neighbour router with the obtained global IP address of the site.

After successful re-connection, the controller 60 starts the downloading stage: using the FTP or the TFTP client, depending on the reservation block, it downloads the configuration file using the data in the reservation block. Once the configuration file has been successfully downloaded, the controller 60 supplies the configuration file to the router system software for processing.

If any failure occurs during execution of any of the three stages described previously, the controller 60 either starts the router autoconfiguration process again, or lets the router system software request manual configuration.

1. A method for configuring a router in a telecommunications network, wherein the information data relating to the configuration of said router are stored in a configuration file in said telecommunications network, said method being characterised in that, after turning said router on and selecting a default interface for said router, said router automatically performs steps comprising:
a connection step, for establishing a logic connection with a predetermined neighbour router, the type of said logic connection depending on the type of said default interface;
an information gathering step, for obtaining, from a predetermined server, information about the location of said configuration file and the way of accessing it; and
a data downloading step, for downloading said configuration file.

2. A method according to claim 1, wherein said network is an IP based mobile access network.

3. (canceled)

4. An apparatus for configuring a router in a telecommunications network, wherein the information data relating to the configuration of said router are stored in a configuration file in said telecommunications network, said apparatus comprising:
connection means, for establishing a logic connection with a predetermined neighbour router, the type of said logic connection depending on the type of a default interface selected for said router;
information gathering means, for obtaining, from a predetermined server, information about the location of said configuration file and the way of accessing it; and
data downloading means, for downloading said configuration file.

5. An apparatus according to claim 4, wherein said connection means comprise a connection manager.

6. An apparatus according to claim 4, wherein said information gathering means comprise a DHCP client.

7. An apparatus according to claim 4, wherein said data downloading means comprise an FTP/TFTP client.

8. An apparatus according to claim 4, wherein said network is an IP based mobile access network.

9. (canceled)
